(19) United States
(12) Patent Application Publication
(10) Pub. No.: US 2013/0320596 A1
(43) Pub. Date: Dec. 5, 2013

(54) MOLTEN PLASTIC FILM PINNING APPARATUS AND METHOD FOR POLYAMIDE OR POLYLACTIC ACID FILM MANUFACTURING PROCESS

(71) Applicant: A.J. PLASTIC PUBLIC COMPANY LIMITED, Bangkok (TH)

(72) Inventor: Kittiphat SUTHISAMPHAT, Bangkok (TH)

(73) Assignee: A.J. PLASTIC PUBLIC COMPANY LIMITED, Bangkok (TH)

(21) Appl. No.: 13/904,446

(22) Filed: May 29, 2013

(30) Foreign Application Priority Data
May 29, 2012 (TH) 1201002517

(51) Int. Cl. B29D 7/01

(52) U.S. Cl. CPC B29D 7/01
USPC 264/466; 425/72.1

(57) ABSTRACT

This invention relates to a molten plastic film pinning apparatus for polyamide (PA) or polylactic acid (PLA) film manufacturing process. The apparatus includes a die for extruding a molten plastic, a chill roll placed under the die for forming and quenching the molten plastic film to the plastic film, an air knife positioned between the die and the chill roll and above the molten plastic film first contacting the chill roll parallelly along the molten plastic film's width, and an electrostatic pinning electrode placed parallel to the air knife. This invention also relates to a molten plastic film pinning method for polyamide (PA) or polylactic acid (PLA) film manufacturing process.

### FIELD OF THE INVENTION

This invention relates to molten plastic film pinning apparatus and method for polyamide or polylactic acid film manufacturing process.

### BACKGROUND OF THE INVENTION

In the plastic film production, e.g. polyamide (PA) or polylactic acid (PLA) film, the production process starts from melting polyamide or polylactic acid granules in the extruder, then melt-extruding via die onto the chill roll to solidify into a plastic film, and then used in the further processes.

One of the crucial factors affecting plastic film quality is how closely contact between the molten plastic film and the chill roll while the molten plastic film solidifies. If the molten plastic film is not closely contact to the chill roll, air may be trapped between the molten plastic film and the chill roll causing a production problem in further production processes and making it unable to remove stain causing by the vapour of molten polymer from the surface of the chill roll. This causes defective spots on the plastic film's surface, raising a quality problem.

Thus, in the plastic film production with good quality requires a process of pinning the molten plastic film in order to pin the molten plastic film closest to the chill roll. At present, there are two systems of pinning the molten plastic film, which are a system using electrostatic charges, and a system using air knife. Each system will have different features, functions and advantages-disadvantages as following:

1. A system using electrostatic charges is employed by using electric current to create electrostatic charges onto the molten plastic film, which is forming to the plastic film. This provides greater closely contact of the molten plastic film with the chill roll, which is connected to the ground wire. The molten plastic film extruding from the die will flow near to electrostatic pinning wire or electrostatic pinning band, which has a voltage of 6-15 kV, creating electrostatic charges on the molten plastic film. When the molten plastic film moves onto the chill roll, which is connected to the ground wire, causing the molten plastic film solidifies and pin to the chill roll.

The system using electrostatic charges can perform well at low speed, but there is a limit at high speed causing an air trap between the molten plastic film and the chill roll. Hence, the plastic film has quality problems. However, this system is still widely used in the production process of polyamide or polylactic acid plastic film, although it cannot perform effectively due to high viscosity of polyamide or polylactic acid. At high speed of chill roll, the pinning force generating from this system is insufficient, for example, in polyamide film production, the chill roll can have a maximum speed of 55 m/s to maintain the plastic film quality.

2. A system using air knife is employed by applying high pressure air over the entire width of the molten plastic film while the molten plastic film is in contact with the chill roll. The 0.5-0.7 bars air pressure is employed to pin the molten plastic film closely contact to the chill roll.

The system using air knife is widely used in polyamide film production process since it can perform well with high viscosity molten plastic film, allowing the chill roll to perform at high speed. However, at high speed, an increase in air pressure on the plastic film's surface may cause defects on the surface of the molten plastic film, causing the quality problem.

US Patent Application No. 2012/0086155 A1 discloses a method for producing aliphatic polyester film, particularly polylactic acid, comprising the steps of melt-extruding an aliphatic polyester as a film, controlling the entrained air stream between a pinning drum and the film while inhibiting the variations of the film edge portion landing points on the pinning drum, and subsequently bringing the film into contact with the pinning drum over the entire width of the film wherein the entrained air stream is controlled by a method of forming a water film on the pinning drum, and/or a method of sucking the air stream by a suction nozzle, and/or provide a shield plate between the rear portion of the die and the pinning drum. The variations of the film edge portion landing points are performed by either a method of spot blowing of air masses or method of applying electrostatic charges.

U.S. Pat. No. 4,038,354 discloses a process for extruding and quenching a polymeric film, especially polyethylene terepthalate films, comprising the steps of extruding a molten polymeric film onto an electrically grounded moving pinning surface, depositing electrostatic charges upon part or the whole of the molten film width by means of an electrostatic pinning electrode arranged in spaced relation to the molten film in the proximity of or prior to the region of first contact of the film with the pinning surface, and applying suction to the space bounded by the path of the molten film prior to its first contact with the pinning surface and that part of the moving pinning surface prior to the region of first contact with the molten film, shortening the path of the molten film, to closely contact the molten film to the pinning surface, and to reduce the effect of neck-in.

### SUMMARY OF THE INVENTION

This invention relates to molten plastic film pinning apparatus and method for polyamide or polylactic acid film manufacturing process.

The objective of this invention is to provide a molten plastic film pinning apparatus and method for polyamide or polylactic acid film manufacturing process, which can make the molten plastic film closely contacted to the chill roll better. This can reduce impurities on the surface of chill roll, increase operational period of the chill roll prior to cleaning, reduce defects on the surface of the plastic film, and provide a better uniform plastic film thickness over the entire width of the plastic film. This provides even better plastic film quality while maintaining the same level of productivity.

According to an embodiment of this invention is to provide molten plastic film pinning apparatus for polyamide or polylactic acid film manufacturing process comprising:
a die for extruding a molten plastic to form the molten plastic film,
a chill roll placed under the die for forming the melt-extruding plastic film and quenching the molten plastic film to the plastic film,
an air knife placed between the die and the chill roll in a position above the molten plastic film first contacting the chill roll parallelly along the molten plastic film's width providing high pressure air onto the molten plastic film's surface over the entire width of the molten plastic film while the molten plastic film in contact with the chill roll to closely contact the molten plastic film to the chill roll. An electrostatic pinning electrode placed parallel to the air knife for generating electrostatic charges onto the molten plastic film's surface over the entire width of the molten plastic film to closely contact the molten plastic film to the chill roll better.

According to another embodiment of this invention is to provide a method of molten plastic film pinning for polyamide or polylactic acid film manufacturing process comprising the steps of
melt-extruding plastic to form the molten plastic film,
applying the first pinning force onto the molten plastic film's surface over the entire width of the molten plastic film while the molten plastic film in contact with the chill roll to closely contact the molten plastic film to the chill roll,
applying the second pinning force onto the molten plastic film's surface over the entire width of the molten plastic film to closely contact the molten plastic film to the chill roll better.

### BRIEF DESCRIPTION OF THE DRAWINGS

FIG. 1 is a perspective view showing a molten plastic film pinning apparatus for polyamide or polylactic acid film manufacturing process according to this invention.

FIG. 2 is a cross-sectional view showing the molten plastic film pinning apparatus for polyamide or polylactic acid film manufacturing process, and an arrangement of air knife and electrostatic pinning electrode according to this invention.

FIG. 3 is a cross-sectional view showing the molten plastic film pinning apparatus for polyamide or polylactic acid film manufacturing process, and another arrangement of air knife and electrostatic pinning electrode according to this invention.

### DETAILED DESCRIPTION OF THE EMBODIMENTS

These and other aspects, features and advantages will become apparent to those of ordinary skill in the art from a reading of the following detailed description, the drawings, and the appended claims.

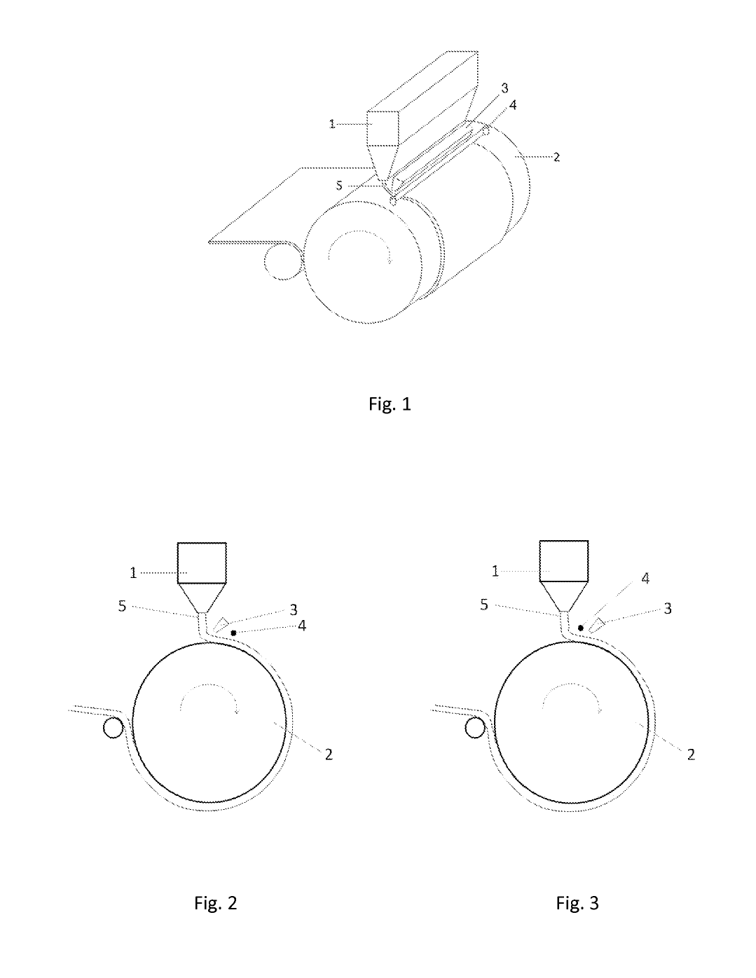

FIGS. 1 to 3 shows the molten plastic film pinning apparatus for polyamide or polylactic acid film manufacturing process according to this invention.

According to an embodiment of this invention, the molten plastic film pinning apparatus for polyamide or polylactic acid film manufacturing process according to this invention comprising
a die (1) for extruding a molten plastic to form the molten plastic film (5),
a chill roll (2) placed under the die (1) for forming the melt-extruding plastic film and quenching the molten plastic film (5) to the plastic film,
an air knife (3) placed between the die (1) and the chill roll (2) in a position above the molten plastic film (5), contacting the chill roll (2) parallelly along the molten plastic film's width (5) providing high pressure air onto the molten plastic film's surface (5) over the entire width of the molten plastic film (5) while the molten plastic film (5) in contact with the chill roll (2) to closely contact the molten plastic film (5) to the chill roll (2),
an electrostatic pinning electrode (4) placed parallel to the air knife (3) for generating electrostatic charges onto the molten plastic film's surface (5) over the entire width of the molten plastic film (5) to closely contact the molten plastic film (5) to the chill roll (2) better,

According to this invention, the air knife (3) are placed in a position capable of generating pinning force onto the surface of the molten plastic film (5) prior to a position where the electrostatic pinning electrode (4) is capable of generating the pinning force onto the surface of the molten plastic film (as illustrated in FIGS. 1 and 2).

Providing the air knife (3) and the electrostatic pinning electrode (4), where the air knife (3) is placed in a position capable of generating pinning force onto the surface of the molten plastic film (5) prior to a position where the electrostatic pinning electrode (4) is capable of generating pinning force onto the surface of the molten plastic film (5). Consequently, the chill roll (2) can operate at high speed using less air pressure than the one using the air knife (3) alone. This minimizes defects on the surface of plastic film, which arises owing to the lesser air pressure force. Positioning the air knife (3) and the electrostatic pinning electrode (4) in such a manner is suitable for high viscosity molten plastic film (5) such as polyamide (PA) plastic film.

According to this invention, the air knife (3) is placed in a position capable of generating pinning force onto the surface of the molten plastic film (5) subsequent to a position where the electrostatic pinning electrode (4) is capable of generating pinning force onto the surface of the molten plastic film (5) (as shown in FIG. 3).

Providing both the air knife (3) and the electrostatic pinning electrode (4), where the air knife (3) is placed in a position capable of generating pinning force onto the surface of the molten plastic film (5) subsequent to a position where the electrostatic pinning electrode (4) is capable of generating pinning force onto the surface of the molten plastic film (5) consequently, the chill roll (2) can operate at high speed using less air pressure than the one using the air knife (3) alone. This provides a uniform thickness over the entire width of the plastic film, and is capable of using less input voltage than the one using the electrostatic pinning electrode (4) alone. This lessens a chance of a short circuit between the electrostatic pinning electrode (4) and the chill roll (2), which causes ragged plastic film and the production of plastic film to stop. Positioning the air knife (3) and the electrostatic pinning electrode (4) in such a manner is suitable for low viscosity molten plastic film (5) such as polylactic acid (PLA) plastic film.

According to this invention, to pin the molten plastic film, the air pressure of the air knife (3) is in a range of 0.4-0.7 bars, the voltage of the electrostatic pinning electrode (4) is in a range of 6-15 kV, and the speed of chill roll (2) is in a range of 20-120 m/min. Preferably, the air pressure of the air knife (3) is in a range of 0.5-0.6 bars, the voltage of the electrostatic pinning electrode (4) is in a range of 8-10 kV, and the speed of chill roll (2) is in a range of 40-80 m/min.

Pinning the molten plastic film, the air pressure of the air knife (3) is in a range of 0.4-0.7 bars, the voltage of the electrostatic pinning electrode (4) is in a range of 6-15 kV, and the speed of chill roll (2) is in a range of 20-120 m/min. Preferably, the air pressure of the air knife (3) is in a range of 0.5-0.6 bars, the voltage of the electrostatic pinning electrode (4) is in a range of 8-10 kV, and the speed of chill roll (2) is in a range of 40-80 m/min. This leads to the molten plastic film (5) well closely contacted to the chill roll (2), which reduces impurities on the surface of the chill roll (2) and increases operational period of the chill roll (2) before cleaning. Additionally, the number of defects on plastic film surface decreases compared to pinning the molten plastic film (5) using only the air knife (3).

According to another embodiment of this invention is to provide the molten plastic film pinning method for polyamide or polylactic acid film manufacturing process comprising the steps of
melt-extruding plastic to form the molten plastic film (5),
applying the first pinning force onto the molten plastic film's surface (5) over the entire width of the molten plastic film (5) while the molten plastic film (5) in contact with the chill roll (2) to closely contact the molten plastic film (5) to the chill roll (2),
applying the second pinning force onto the molten plastic film's surface (5) over the entire width of the molten plastic film (5) to closely contact the molten plastic film (5) to the chill roll (2) better,

According to this invention, the first pinning force is applied by providing high pressure air using air knife (3).

According to this invention, the second pinning force is applied by applying the pinning force from the electrostatic charges caused by the electrostatic pinning electrode (4).

According to this invention, the first pinning force is applied prior to or subsequent to the second one.

According to this invention, to pin the molten plastic film, the air pressure of the air knife (3) is in a range of 0.4-0.7 bars, the voltage of the electrostatic pinning electrode (4) is in a range of 6-15 kV, and the speed of chill roll (2) is in a range of 20-120 m/min. Preferably, the air pressure of the air knife (3) is in a range of 0.5-0.6 bars, the voltage of the electrostatic pinning electrode (4) is in a range of 8-10 kV, and the speed of chill roll (2) is in a range of 40-80 m/min.

According to this invention, the molten plastic film pinning method for polyamide or polylactic acid film manufacturing process using the molten plastic film pinning apparatus as above-mentioned embodiments.

The following presents experimental results between the molten plastic film pinning system according to this invention and the conventional molten plastic film pinning systems. The experiment was conducted in the production process of polyamide or polylactic acid film using the air knife (3) placed in a position capable of generating pinning force onto the surface of the molten plastic film (5) prior to generating pinning force onto the surface of the molten plastic film (5) of the electrostatic pinning electrode (4).

TABLE 1
An average number of defects on plastic film
surface at various speed (spot/10,000 m²)

| | Molten plastic film | Molten plastic film | Molten plastic |
|---|---|---|---|
| Chill roll | pinning apparatus | pinning apparatus | film pinning |
| speed | according to this | using electrostatic | apparatus using |
| (m/min.) | invention | pinning electrode | air knife |
| 50 | 1 | 0 | 8 |
| 60 | 1 | n/a | 14 |
| 70 | 2 | n/a | 27 |

Remarks:

1. Inline Inspection system was used to count defective spot of the size 1.0×1.0 mm or greater.

2. For each molten plastic film pinning apparatus, an average number of defects at various chill roll speed was measured for consecutive 8 hours without changing other variables in the system.

3. The chill roll in the molten plastic film pinning apparatus using electrostatic pinning electrode could not perform beyond speed of 55 m/min., hence; the results at 60 m/min. and 70 m/min. speed were unmeasurable.

From Table 1, it can be seen that conventional molten plastic film pinning apparatuses, especially the one using only air knife, has higher number of defects as the chill roll speed is increasing. The molten plastic film pinning apparatus according to this invention can significantly reduce the defects on the plastic film's surface in all speed.

TABLE 2
An average standard deviation of plastic
film thickness (2-sigma value)

| | Molten plastic film | Molten plastic film | Molten plastic |
|---|---|---|---|
| Chill roll | pinning apparatus | pinning apparatus | film pinning |
| speed | according to this | using electrostatic | apparatus using |
| (m/min.) | invention | pinning electrode | air knife |
| 50 | 0.91 | 1.34 | 1.38 |
| 60 | 0.89 | n/a | 1.52 |
| 70 | 0.98 | n/a | 1.49 |

From Table 2, it can be seen that an average standard deviation of plastic film thickness of molten plastic film pinning apparatus of this invention is significantly lower than the one using conventional molten plastic film pinning apparatus, especially the one using air knife. This is because the molten plastic film pinning apparatus of this invention can apply lower air pressure than the one using only air knife. This provides more consistent plastic film thickness along the plastic film width, and also better quality.

TABLE 3
Operational period of chill roll before each cleaning (hour)

| | Molten plastic film | Molten plastic film | Molten plastic |
|---|---|---|---|
| Chill roll | pinning apparatus | pinning apparatus | film pinning |
| speed | according to this | using electrostatic | apparatus using |
| (m/min.) | invention | pinning electrode | air knife |
| 50 | 48 | 20 | 24 |
| 60 | 42 | n/a | 21 |
| 70 | 38 | n/a | 18 |

From Table 3, it can be seen that, for the molten plastic film pinning apparatus of this invention, the operational period of chill roll before each cleaning is longer than the one using only either the electrostatic pinning electrode or the air knife. This results in greater continuous plastic film production, and lesser number of chill roll cleaning time.

In this specification, the term “pin” means bringing the molten plastic film (5) closely contact with the chill roll (2).

It will be appreciated that, although specific embodiments of the present disclosure have been described herein for purposes of illustration, various modifications or alteration may be made without departing from the spirit and scope of the disclosure. Accordingly, the disclosure is not limited except as by the appended claims.

The entire disclosures of all applications, patents and publications, cited herein and of corresponding TH Patent Application No. 1201002517, filed May 29, 2012, are incorporated by reference herein.

1. A molten plastic film pinning apparatus for polyamide or polylactic acid film manufacturing process comprising:
a die for extruding a molten plastic to form the molten plastic film,
a chill roll placed under the die for forming the melt-extruding plastic film and quenching the molten plastic film to the plastic film,
an air knife placed between the die and the chill roll in a position above the molten plastic film, first contacting the chill roll parallelly along the molten plastic film's width providing high pressure air onto the molten plastic film's surface over the entire width of the molten plastic film while the molten plastic film in contact with the chill roll to closely contact the molten plastic film to the chill roll,
an electrostatic pinning electrode placed parallel to the air knife for generating electrostatic charges onto the molten plastic film's surface over the entire width of the molten plastic film to closely contact the molten plastic film to the chill roll better,
wherein the air pressure of the air knife is in a range of 0.4-0.7 bars, the voltage of the electrostatic pinning electrode is in a range of 6-15 kV, and the chill roll speed is in a range of 20-120 m/min.

2. The apparatus according to claim 1, wherein the air pressure of the air knife is in a range of 0.5-0.6 bars, the voltage of the electrostatic pinning electrode is in a range of 8-10 kV, and the chill roll speed is in a range of 40-80 m/min.

3. The apparatus according to claim 1, wherein the air knife is placed in a position capable of generating pinning force onto the surface of the molten plastic film prior to a position where the electrostatic pinning electrode is capable of generating the force.

4. The apparatus according to claim 1, wherein the air knife is placed in a position capable of generating pinning force onto the surface of the molten plastic film subsequent to a position where the electrostatic pinning electrode is capable of generating the force.

5. A molten plastic film pinning method for polyamide or polylactic acid film manufacturing process comprising the steps of:
melt-extruding plastic to form the molten plastic film,
applying the first pinning force onto the molten plastic film's surface over the entire width of the molten plastic film while the molten plastic film in contact with the chill roll to closely contact the molten plastic film to the chill roll,
applying the second pinning force onto the molten plastic film's surface over the entire width of the molten plastic film to closely contact the molten plastic film to the chill roll better,
wherein the first pinning force is provided by the high pressure air using the air knife, and the second pinning force is provided by the electrostatic pinning electrode, using the air pressure in a range of 0.4-0.7 bar, the voltage of the electrostatic pinning electrode in a range of 6-15 kV, and the chill roll speed in a range of 20-120 m/min.

6. The method according to claim 5, wherein the air pressure of the air knife is in a range of 0.5-0.6 bars, the voltage of the electrostatic pinning electrode is in a range of 8-10 kV, and the chill roll speed is in a range of 40-80 m/min.

7. The method according to claim 5, wherein the first pinning force is applied prior to the second one.

8. The method according to claim 5, wherein the first pinning force is applied subsequent to the second one.
